(19) United States
(12) Patent Application Publication
(10) Pub. No.: US 2025/0112546 A1
(43) Pub. Date: Apr. 3, 2025

(54) ISOLATED CONVERTER

(71) Applicant: DAIHEN CORPORATION, Osaka (JP)

(72) Inventors: Shingo KAWANO, Osaka-shi Osaka (JP); Kota Shimomura, Osaka-shi Osaka (JP)

(21) Appl. No.: 18/897,346

(22) Filed: Sep. 26, 2024

(30) Foreign Application Priority Data
Sep. 29, 2023 (JP) 2023-170005
Sep. 29, 2023 (JP) 2023-170179
Sep. 29, 2023 (JP) 2023-170370

(51) Int. Cl. H02M 3/00; H01F 27/22; H01F 27/24; H01F 27/28; H02M 3/335

(52) U.S. Cl. CPC H02M 3/003; H01F 27/22; H01F 27/24; H01F 27/2804; H02M 3/33569

(57) ABSTRACT

Heat of a primary-side circuit board and a secondary-side circuit board generated, for example, during use of an isolated converter sometimes fails to be sufficiently released from a casing. In an isolated converter, an inverter circuit board (the primary-side circuit board) is opposed to one sidewall at an interval so as to extend along the one sidewall of a casing, and a rectifier circuit board (the secondary-side circuit board) is opposed to another sidewall at an interval so as to extend along the other sidewall of the casing. The casing has an internal space (S) in which a mold material (M) with an insulating property is filled to seal a transformer, the inverter circuit board, and the rectifier circuit board in the internal space (S) of the casing.

### RELATED APPLICATIONS

The present application claims priority to Japanese patent application JP 2023-170005 filed on Sep. 29, 2023, Japanese patent application JP 2023-170179 filed on Sep. 29, 2023, and Japanese patent application JP 2023-170370 filed on Sep. 29, 2023, the entire content of which is hereby incorporated by reference into this application.

### BACKGROUND OF THE INVENTION

### 1. Technical Field

The present invention relates to an isolated converter including a transformer.

### 2. Description of the Related Art

For example, JP 2016-4928 A discloses an isolated converter including a transformer. The transformer is housed within a housing having an insulating property. The transformer is electrically connected to an inverter circuit board and a rectifier circuit board outside the housing. The transformer, the inverter circuit board (a primary-side circuit board), and the rectifier circuit board (a secondary-side circuit board) are housed in a metallic casing.

### SUMMARY OF THE INVENTION

However, when a transformer, a primary-side circuit board, and a secondary-side circuit board are housed in one casing having an insulating property, the heat of the primary-side circuit board and the secondary-side circuit board generated, for example, during use of an isolated converter sometimes fails to be sufficiently released from the casing.

The present invention has been made in consideration of the above, and provides an isolated converter that enables ensuring a heat dissipation characteristic in a housing even when a transformer, a primary-side circuit board, and a secondary-side circuit board are housed within one housing while ensuring an insulating property of the transformer.

In view of the aforementioned problems, an isolated converter according to the present invention includes a transformer, a primary-side circuit board, and a secondary-side circuit board. The transformer includes a coil board having a first coil pattern that functions as a primary coil and a second coil pattern that functions as a secondary coil, and a core that electromagnetically couples the first coil pattern to the second coil pattern. The primary-side circuit board is electrically connected to the first coil pattern at one end of the coil board. The secondary-side circuit board electrically connected to the second coil pattern at another end of the coil board. The isolated converter includes a casing with an insulating property that houses the transformer, the primary-side circuit board, and the secondary-side circuit board. The primary-side circuit board is opposed to one sidewall at an interval so as to extend along the one sidewall of a pair of sidewalls of the casing. The secondary-side circuit board is opposed to another sidewall at an interval so as to extend along the other sidewall of the pair of sidewalls of the casing. The casing has an internal space in which a mold material with an insulating property is filled to seal the transformer, the primary-side circuit board, and the secondary-side circuit board with the mold material in the internal space of the casing.

With the present invention, current is energized in the primary-side circuit board and the secondary-side circuit board during use of the isolated converter, and therefore, a heat is generated. Here, the primary-side circuit board is opposed to one sidewall at an interval so as to extend along the one sidewall of a pair of sidewalls of the casing, and a mold material fills a space between the primary-side circuit board and the other sidewall. Accordingly, the heat generated in the primary-side circuit board is easily released from the one sidewall of the casing via the mold material. Similarly, the secondary-side circuit board is opposed to the other sidewall at an interval so as to extend along the other sidewall of the pair of sidewalls of the casing, and the mold material fills a space between the secondary-side circuit board and the other sidewall. Accordingly, the heat generated in the secondary-side circuit board is easily released from the other sidewall of the casing via the mold material. Even when the transformer, the primary-side circuit board, and the secondary-side circuit board are housed in one casing, the pair of sidewalls of the casing enables efficiently releasing the heat generated from the primary-side circuit board and the secondary-side circuit board.

In a preferred aspect, the one sidewall has an outer surface on which an input board is installed, an electrolytic capacitor and an input terminal electrically connected to the primary-side circuit board are mounted on the input board, and the other sidewall has an outer surface on which an output board is installed, an electrolytic capacitor and an output terminal electrically connected to the secondary-side circuit board are mounted on the output board.

With the aspect, the electrolytic capacitors are mounted on the input board and the output board, and are disposed outside with respect to the casing, thereby enabling reduced transmission of the heat while the mold material fills the casing and the heat generated inside the casing during use of the isolated converter to the electrolytic capacitors.

In a further preferred aspect, a pair of installation members for installing the casing are disposed between the input board and the one sidewall and between the output board and the other sidewall, and each of the installation members has a space formed at a portion where the electrolytic capacitor is positioned.

With the aspect, the pair of installation members enable installation of the casing on an external device. Furthermore, the installation members are provided with the spaces at the portions where the electrolytic capacitors are positioned, and thus, these spaces function as heat-insulating layers and the effect of heat transmitted from the casing to the electrolytic capacitors is reducible during filling of the mold material and during use of the isolated converter.

In a more preferred aspect, the internal space of the casing is filled with a mold material having a relative dielectric constant lower than a relative dielectric constant of an insulating material of the board main body constituting the coil board, for the mold material.

With the aspect, the mold material internally filling the casing has the relative dielectric constant lower than the relative dielectric constant of the insulating material of the board main body while the pressure resistance of the transformer is ensured, thereby enabling suppressed increase in the parasitic capacitance caused by the mold material.

In a more preferred aspect, the primary-side circuit board is integrally installed on the coil board so as to extend in a direction perpendicular to the coil board at the one end of the coil board, and the secondary-side circuit board is integrally installed on the coil board so as to extend in a direction perpendicular to the coil board at the other end of the coil board.

With the aspect, the primary-side circuit board and the secondary-side circuit board are integrally installed on the coil board at both the ends of the coil board. Thus, the coil board, the primary-side circuit board, and the secondary-side circuit board can be handled as one downsized board structure. Thus, relative positions of the coil board, the primary-side circuit board, and the secondary-side circuit board with the core are easily managed, and assembly efficiency of the isolated converter can be enhanced.

Furthermore, the primary-side circuit board and the secondary-side circuit board are integrally installed on the coil board so as to extend in the direction perpendicular to the coil board, and therefore, the casing that houses these boards can be reduced in size compared with the case where these boards are arranged on the same plane. Thus, attempting a downsized isolated converter enables achieving a lowered footprint.

In a more preferred aspect, the primary-side circuit board and the secondary-side circuit board are secured on a pair of opposed sidewalls of the casing to hold the coil board in the casing.

With the aspect, the primary-side circuit board and the secondary-side circuit board are secured to the pair of opposed sidewalls of the casing, and thus, deformation and distortion caused by a dimensional error and the like during installation are absorbed by the primary-side circuit board and secondary-side circuit board, and the coil board can be held in the casing. Thus, deformation, distortion, and the like of the coil board caused by directly installing the coil board on the casing can be suppressed, and therefore, the coil board is accurately installable on the core.

In a more preferred aspect, the coil board is provided with a first insertion hole and a second insertion hole, the first insertion hole has a peripheral area where the first coil pattern is formed, and the second insertion hole has a peripheral area where the second coil pattern is formed. The core has a first magnetic portion inserted through the first insertion hole and a second magnetic portion inserted through the second insertion hole. Spacers that position the first insertion hole with respect to the first magnetic portion and position the second insertion hole with respect to the second magnetic portion are disposed between the primary-side circuit board and the secondary-side circuit board and respective inner surfaces of the sidewalls.

With the aspect, the spacer is interposed between the one sidewall of the casing and the primary-side circuit board, and the spacer is interposed between the other sidewall of the casing and the secondary-side circuit board. Thus, the first insertion hole can be positioned at a position at which the parasitic capacitance is minimized with respect to the first magnetic portion of the core and the second insertion hole can be positioned at a position at which the parasitic capacitance is minimized with respect to the second magnetic portion of the core, in the casing.

In a more preferred aspect, the spacer is fixedly secured to each of the primary-side circuit board and the secondary-side circuit board. A fastener inserted through each of the sidewalls is screwed in the spacer to install the primary-side circuit board and the secondary-side circuit board on the casing.

With the aspect, the fasteners inserted through the respective sidewalls are screwed in the respective spacers fixedly secured to the primary-side circuit board and the secondary-side circuit board, and thus, the primary-side circuit board and the secondary-side circuit board can be installed on the casing. In particular, with the aspect, only by fastening the fasteners, both the first magnetic portion and the second magnetic portion of the core can be positioned at positions at which the parasitic capacitances of the first insertion hole and the second insertion hole of the coil board are minimized.

In a more preferred aspect, the isolated converter is a DC-DC converter. The primary-side circuit board is an inverter circuit board that includes a switching element, converts a DC power into an AC power by the switching element, and supplies the AC power to the coil board. The secondary-side circuit board is a rectifier circuit board that rectifies a current output from the coil board.

With the aspect, while the inverter circuit board and the rectifier circuit board are likely to generate a heat during the energization, the inverter circuit board and the rectifier circuit board are disposed to be opposed to the pair of respective sidewalls of the casing, and thus, the heat dissipation characteristic of the DC-DC converter can be ensured.

The isolated converter according to the present invention enables ensuring a heat dissipation characteristic in a housing even when a transformer, a primary-side circuit board, and a secondary-side circuit board are housed within one housing while ensuring an insulating property of the transformer.

### BRIEF DESCRIPTION OF THE DRAWINGS

FIG. 1 is a schematic perspective view of an isolated converter according to an embodiment of the present invention;

FIG. 2 is a schematic perspective view of the isolated converter in FIG. 1 viewed from another side;

FIG. 3 is a center cross-sectional view of the isolated converter illustrated in FIG. 1;

FIG. 4 is a cross-sectional view for describing an installed state of a coil board illustrated in FIG. 1;

FIG. 5 is a schematic perspective view of a core of the isolated converter illustrated in FIG. 1;

FIG. 6 is an exploded perspective view of the core illustrated in FIG. 5;

FIG. 7 is a schematic perspective view of the coil board illustrated in FIG. 1;

FIG. 8 is a schematic perspective view for describing first and second coil patterns of the coil board illustrated in FIG. 7;

FIG. 9 is a plan view for describing the first and second coil patterns of the coil board illustrated in FIG. 8;

FIG. 10A is a plan view of a single layer board as a first layer of the coil board;

FIG. 10B is a plan view of a single layer board as a second layer of the coil board;

FIG. 10C is a plan view of a single layer board as a third layer of the coil board;

FIG. 11A is a plan view of a single layer board as a fifth layer of the coil board;

FIG. 11B is a plan view of a single layer board as a sixth layer of the coil board;

FIG. 11C is a plan view of a single layer board as a seventh layer of the coil board;

FIG. 12A is a plan view of a single layer board as a tenth layer of the coil board;

FIG. 12B is a plan view of a single layer board as an eleventh layer of the coil board;

FIG. 12C is a plan view of a single layer board as a twelfth layer of the coil board;

FIG. 13A is a conceptual diagram for describing a current flow in a first coil pattern of the coil board;

FIG. 13B is a conceptual diagram for describing a current flow in a second coil pattern of the coil board;

FIG. 14 is a perspective view of a board including the coil board illustrated in FIG. 1;

FIG. 15 is a perspective view including a transformer illustrated in FIG. 1; and

FIG. 16 is perspective view for describing installation of a rectifier circuit board illustrated in FIG. 1.

### DETAILED DESCRIPTION OF THE PREFERRED EMBODIMENTS

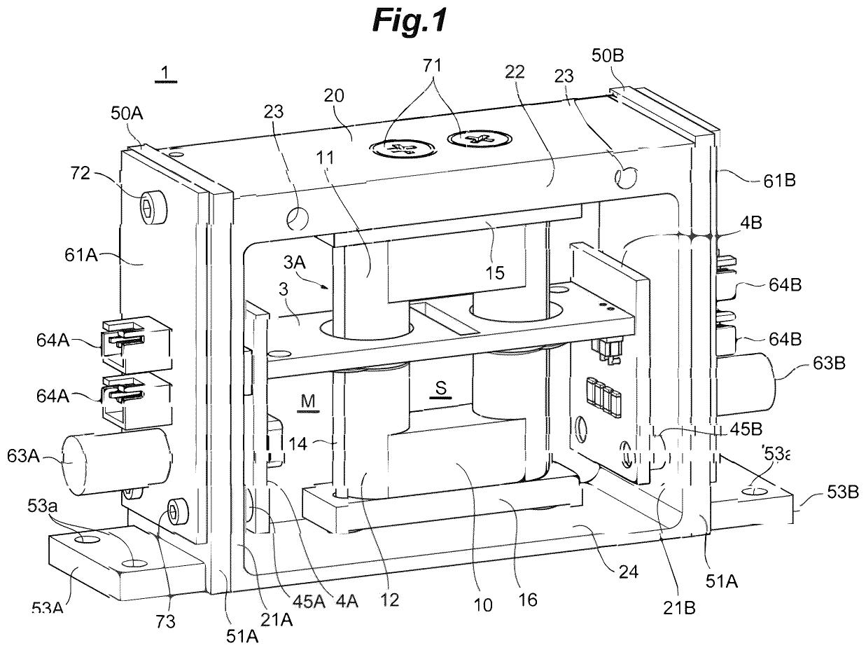

The following will describe an isolated converter according to an embodiment of the present invention by referring to FIG. 1 to FIG. 16.

### 1. Overall Structure of Isolated Converter 1

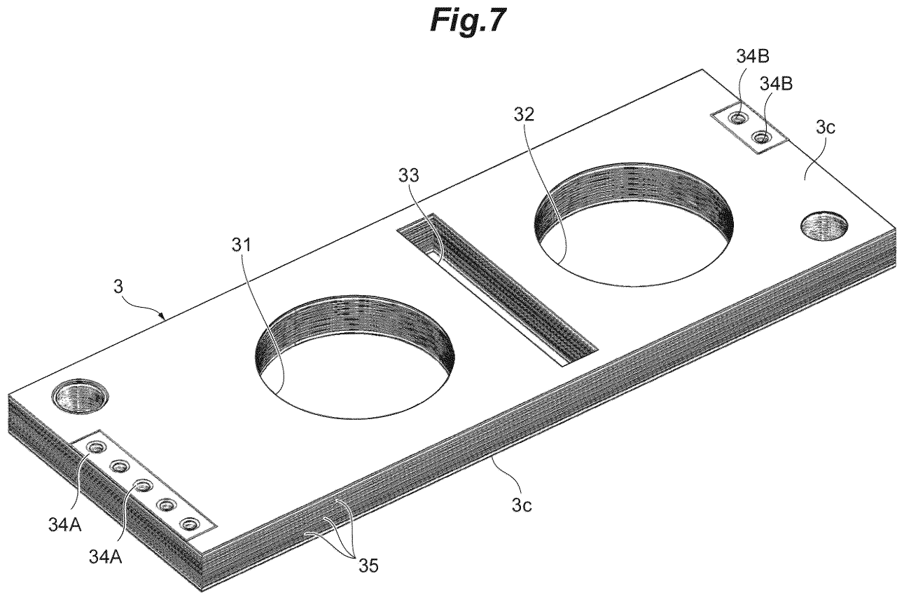

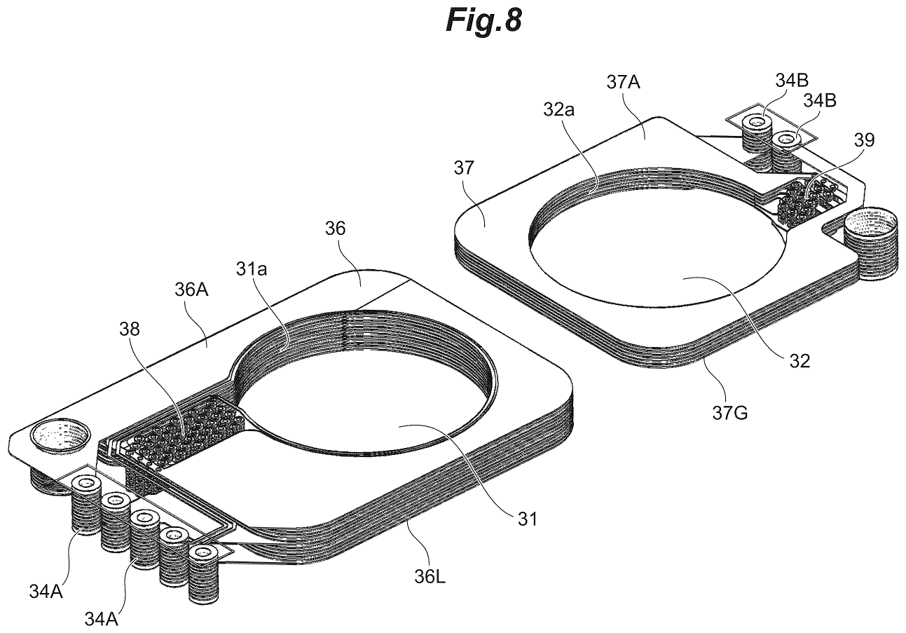

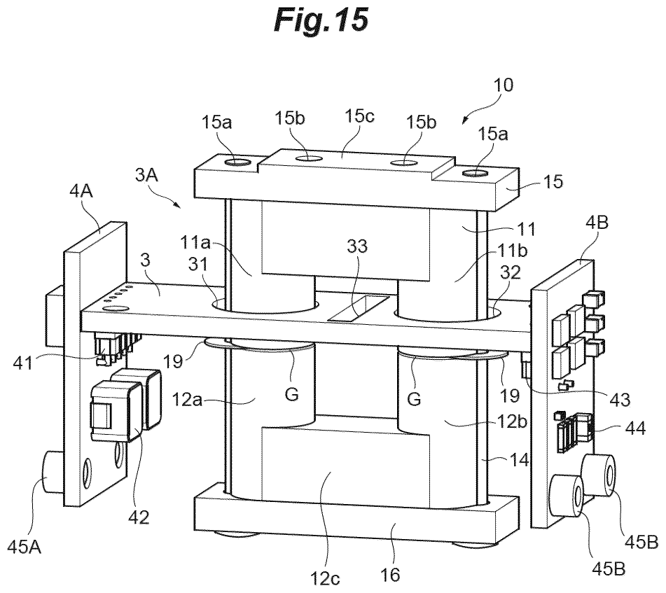

An isolated converter 1 according to the embodiment is a DC-DC converter, and includes a transformer 3A. The transformer 3A is an iron-core transformer including a coil board 3 and a core 10. The coil board 3 has a first coil pattern 36 that serves as a primary coil of the transformer 3A and a second coil pattern 37 that serves as a secondary coil of the transformer 3A as described later with reference to FIG. 7 and FIG. 8. As described later with reference to FIG. 7 and FIG. 15, the core 10 electromagnetically couples the first coil pattern 36 to the second coil pattern 37.

The isolated converter 1 further includes a primary-side circuit board and a secondary-side circuit board. In the embodiment, the primary-side circuit board is an inverter circuit board 4A, and the inverter circuit board 4A is electrically connected to the first coil pattern 36 at one end of the coil board 3. In the embodiment, the secondary-side circuit board is a rectifier circuit board 4B, which is electrically connected to the second coil pattern 37 at the other end of the coil board 3.

The inverter circuit board 4A includes an electronic component 42, such as a switching element, mounted on a board main body (for example, a glass epoxy board) on which a wiring pattern is provided, and forms an inverter circuit. The inverter circuit board 4A converts a DC power into an AC power by means of the switching element, and thus, the AC power is supplied to the coil board 3.

The rectifier circuit board 4B includes an electronic component 44, such as a diode, mounted on a board main body (for example, a glass epoxy board) on which a wiring pattern is provided, and forms a rectifier circuit that rectifies the current (voltage) output from the coil board 3. The inverter circuit and the rectifier circuit in the DC-DC converter are generally known circuits, and therefore, the detailed description is omitted.

While the DC-DC converter is exemplarily described as the isolated converter 1 in the embodiment, the primary-side circuit board is, for example, a rectifier circuit board that includes an electric circuit for AC-DC conversion further including four diodes when the isolated converter 1 is a switching type AC-DC converter. As a result, the AC-DC converter has a configuration including the electric circuit for AC-DC conversion and the DC-DC converter.

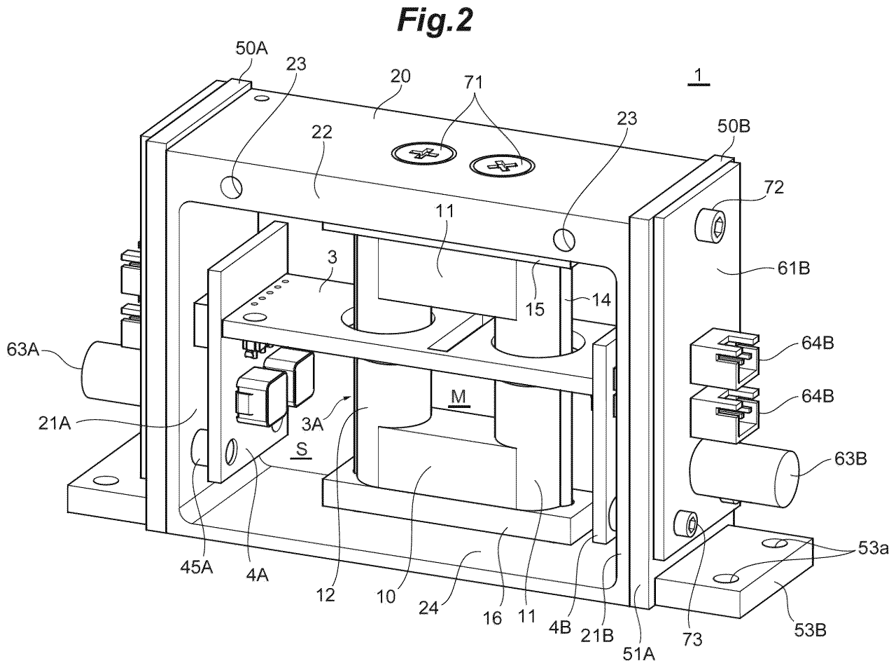

The isolated converter 1 further includes a casing 20 with an insulating property. The casing 20 houses the transformer 3A, the inverter circuit board 4A, and the rectifier circuit board 4B. In FIG. 1 and FIG. 2, the casing 20 is in a state in which a lid body (not illustrated) at a front is removed. The lid body is installed on the casing 20 with a fastener (not illustrated) screwed in a screw hole 23.

In the embodiment, the casing 20 is made of a resin material with an insulating property. The resin material is not specifically limited as long as it can ensure the insulating property, and the examples may include engineering plastics. The engineering plastic may be a crystalline plastic, such as polyphenylene sulfide (PPS). Furthermore, from the aspects of heat resistance and ensuring strength, for example, an amorphous plastic made from polyetherimide (PEI), such as ULTEM (registered trademark), is preferred.

The inverter circuit board 4A is opposed to one sidewall 21A at an interval so as to extend along the one sidewall 21A of the casing 20. On the other hand, the rectifier circuit board 4B is opposed to another sidewall 21B at an interval so as to extend along the other sidewall 21B of the casing 20. An input board 61A on which an electrolytic capacitor 63A and input terminals 64A electrically connected to the inverter circuit board 4A are mounted is installed on the outer surface of the one sidewall 21A of the casing 20. An output board 61B on which an electrolytic capacitor 63B and output terminals 64B electrically connected to the rectifier circuit board 4B are mounted is installed on the outer surface of the other sidewall 21B of the casing 20. The electrolytic capacitor 63A constitutes a part of a smoothing circuit that smooths a pulsating flow of current input to the inverter circuit board 4A, and the electrolytic capacitor 63B constitutes a part of a smoothing circuit that smooths a pulsating flow of current output from the rectifier circuit board 4B.

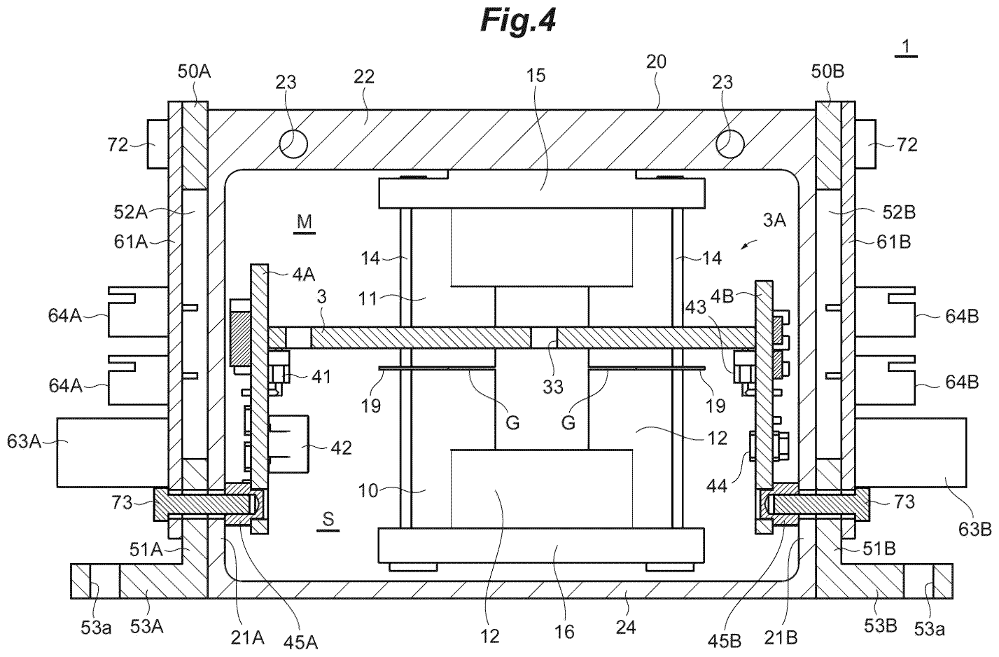

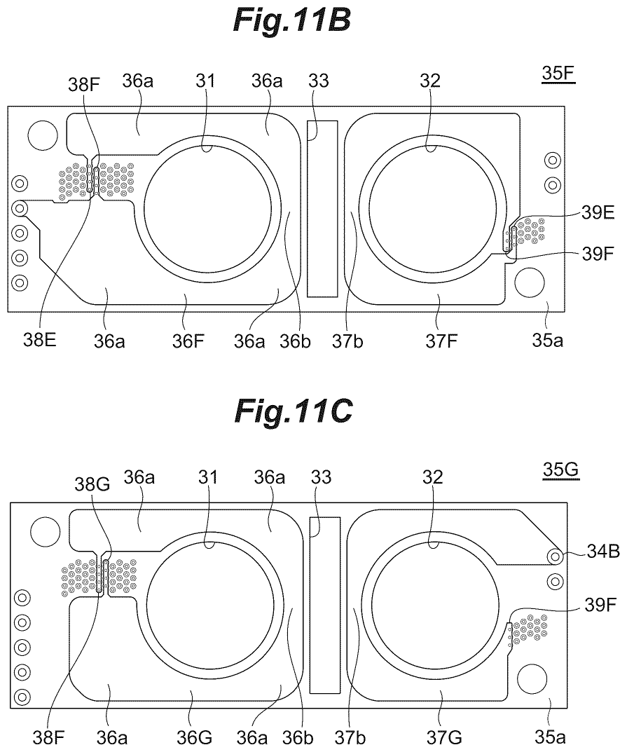

In the embodiment, a pair of installation members 50A, 50B for installing the casing 20 on an external structure (not illustrated) are disposed between the input board 61A and the one sidewall 21A and between the output board 61B and the other sidewall 21B. Each installation member 50A (50B) is installed on the casing 20 by screwing (fastening) a fastener 72 in the casing 20 together with the input board 61A (the output board 61B). In the embodiment, as described later with reference to FIG. 4 and FIG. 11, a fastener 73 is inserted through the casing 20 without being screwed, and is screwed (fastened) in a spacer 45A (45B) secured on the inverter circuit board 4A (the rectifier circuit board 4B).

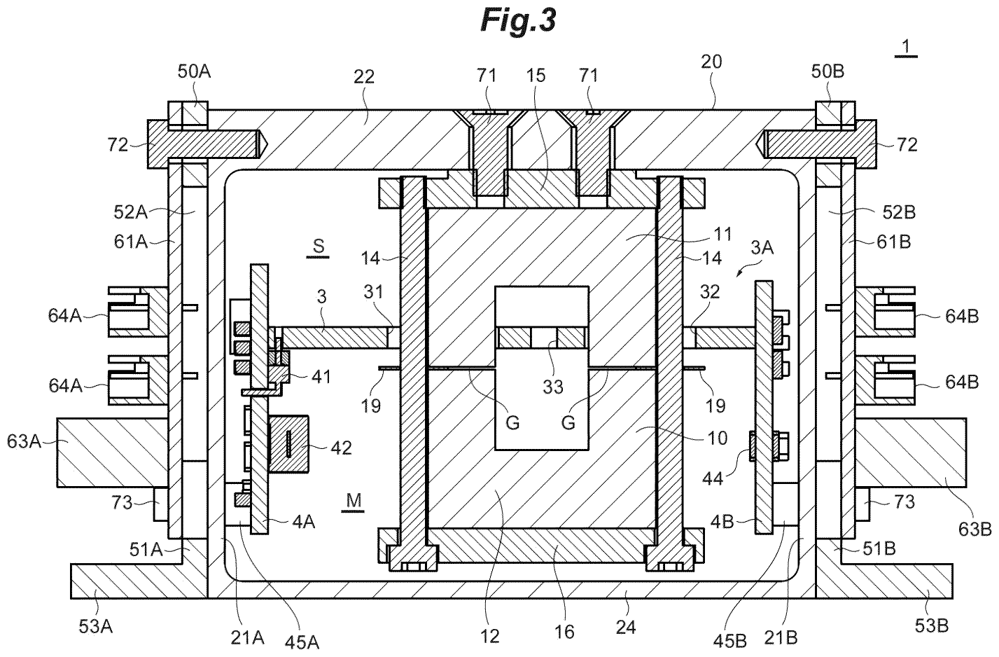

Each installation member 50A (50B) has a frame-shaped main body 51A (51B) pro-vided with a space 52A (52B) as illustrated in FIG. 3 and a leg 53A (53B) that projects from the main body 51A (51B) and is provided with installation holes 53a. The space 52A (52B) houses wirings and the like that connect the electrolytic capacitor 63A (63B) and the input terminals 64A (the output terminals 64B) to the inverter circuit board 4A (the rectifier circuit board 4B).

### 2. Core 10

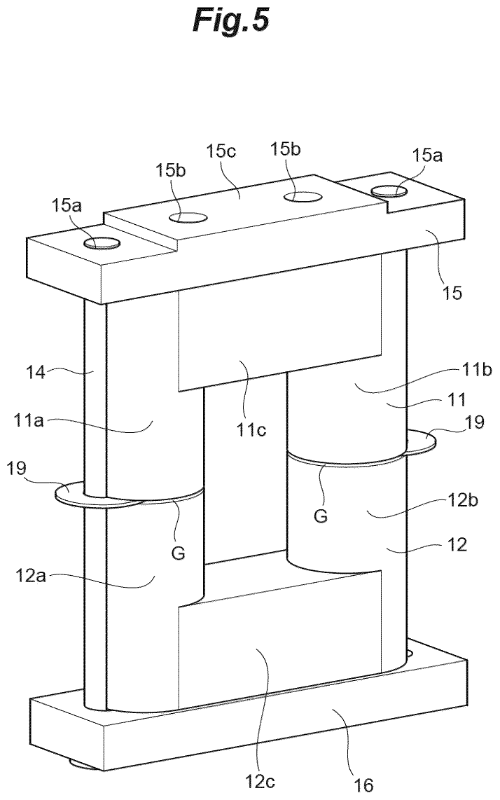

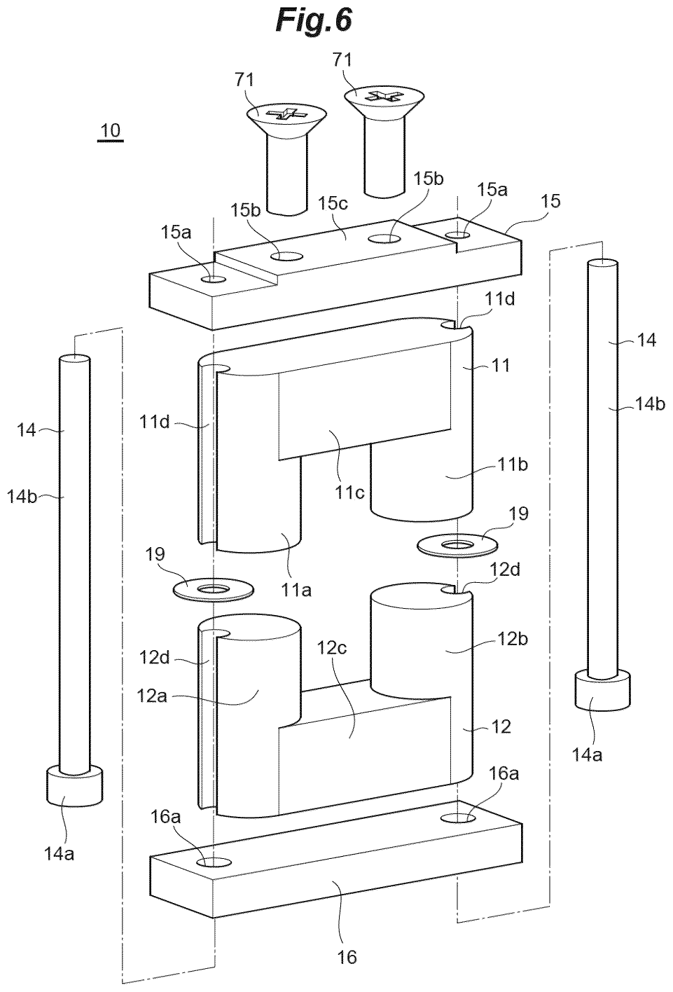

The core 10 electromagnetically couples the first coil pattern 36 of the coil board 3 to the second coil pattern 37 (see FIG. 8). As illustrated in FIG. 5 and FIG. 6, the core 10 has U-shaped divided bodies 11, 12, and the divided bodies 11, 12 are formed bodies (for example, dust cores) formed from a soft magnetic material, such as ferrite (iron).

One divided body 11 has a first magnetic portion 11a inserted through a first insertion hole 31 provided in the coil board 3 illustrated in FIG. 15 and a second magnetic portion 11b inserted through a second insertion hole 32. As illustrated in FIG. 5, the first magnetic portion 11a and the second magnetic portion 11b are joined by a joining portion 11c. The other divided body 12 has a first magnetic portion 12a and a second magnetic portion 12b at respective positions opposed to the first magnetic portion 11a and the second magnetic portion 11b, and the first magnetic portion 12a and the second magnetic portion 12b are joined by a joining portion 12c.

As illustrated in FIG. 6, washers 19 with an insulating property are interposed between the one divided body 11 and the other divided body 12, and thus, gaps G (see FIG. 3) are formed therebetween. The divided bodies 11, 12 have grooves 11d, 12d formed along the first magnetic portions 11a, 12a and the second magnetic portions 11b, 12b.

When the core 10 is assembled, the divided bodies 11, 12 are interposed between a pair of holding blocks 15, 16 with the washers 19 being disposed, and a shaft 14b of a connecting bolt 14 is inserted through one of holes 16a of the holding block 16. At this time, the shaft 14b is further inserted through the washer 19 and is housed within the grooves 12d, 11d. This state is maintained, and at the same time, the shaft 14b is screwed into a screw hole 15a passing through the other holding block 15, and thus, the connecting bolt 14 is tightened.

In the embodiment, the screw hole 15a is a screw hole passing through the other holding block 15, and therefore, adjusting the tightening amount of the connecting bolt 14 enables to adjust the size of the gap G formed between the divided bodies 11 and 12 into a desired size. Furthermore, portions where the screw holes 15a are formed in the other holding block 15 are depressed with respect to an abutting surface 15c described later. This depressed portion acts as a relief portion when a tip of the connecting bolt 14 sticks out by tightening. The pair of holding blocks 15, 16 and the connecting bolt (the fastener) 14 are made from a non-magnetic material, such as a resin or a ceramic.

Thus, the divided bodies 11, 12 enable forming a magnetic circuit (magnetic path) of the primary coil and the secondary coil of the transformer 3A. When the core 10 is assembled, as illustrated in FIG. 15, the core 10 is assembled with the coil board 3 being disposed in the core 10.

The core 10 thus assembled is installed on the casing 20. Specifically, the abutting surface 15c in a planar shape that abuts on an inner surface (a planar surface) of an upper wall 22 of the casing 20 is formed on the other holding block 15, and the abutting surface 15c has screw holes 15b formed therein. Fixation screws (fixtures) 71 are inserted through the upper wall 22 of the casing, the fixation screws 71 are screwed into the screw holes 15b, and the fixation screws 71 are tightened.

Thus, the planar abutting surface 15c of the other holding block 15 is brought into contact with the upper wall 22 of the casing 20, which allows the core 10 to be accurately installed on the casing 20, and the core 10 obtains a hanging state floating from a bottom wall 24 of the casing 20. Furthermore, as soon as the connecting bolt 14 is fastened, a stress acts on the one holding block 16 in the direction of pressing a head 14a of the connecting bolt 14 into the one holding block 16. As a result, the connecting bolt 14 causes a large stress to act on the one holding block 16, compared with the other holding block 15. On the other holding block 15, a stress caused by the fastening of the fixation screw 71 acts. Thus, the stresses caused by the head 14a of the connecting bolt 14 and the fixation screw 71 are dispersible to the pair of holding blocks 15, 16, and therefore, strength of the isolated converter can be stably ensured when the core 10 is assembled to the casing 20.

### 3. Coil Board 3

The coil board 3 has the first insertion hole 31 through which the first magnetic portion 11a of the core 10 is inserted and the second insertion hole 32 through which the second magnetic portion 11b of the core 10 is inserted. The first insertion hole 31 and the second insertion hole 32 are circular-shaped through-holes. The first magnetic portion 11a has an approximately cylindrical shape, and the first insertion hole 31 is larger than the circular-shaped cross-sectional surface of the first magnetic portion 11a. Thus, there is formed a clearance for assembly adjustment between the peripheral edge of the first insertion hole 31 and the first magnetic portion 11a. Similarly, the second magnetic portion 11b has an approximately cylindrical shape, and the second insertion hole 32 is larger than the circular-shaped cross-sectional surface of the second magnetic portion 11b. Thus, there is formed a clearance for assembly adjustment between the peripheral edge of the second insertion hole 32 and the second magnetic portion 11b.

The coil board 3 is provided with a through-hole 33 that passes through so as to partition the first insertion hole 31 and the second insertion hole 32. When the through-hole 33 is not filled with a mold material described later, a space is formed (where air is present) between the first coil pattern 36 and the second coil pattern 37 because of the through-hole 33, and therefore, a parasitic capacitance therebetween can be reduced compared with the case where there is no through-hole 33 provided. However, as described later, when an internal space S of the casing 20 is filled with the mold material, it is filled with a mold material having a relative dielectric constant lower than a relative dielectric constant of an insulating material of a board main body 35a constituting the coil board 3. Thus, the through-hole 33 is also filled with the mold material having the relative dielectric constant lower than the relative dielectric constant of the insulating material of the board main body 35a, and therefore, the parasitic capacitance between the first coil pattern 36 and the second coil pattern 37 can be reduced.

In the embodiment, as illustrated in FIG. 8, the coil board 3 has the first coil pattern 36 with a conductive property in a peripheral area of the first insertion hole 31 and the second coil pattern 37 in a peripheral area of the second insertion hole 32. As illustrated in FIG. 7, an insulating layer 3c coats surfaces of both sides of the coil board 3. Thus, electrical discharge between the first coil pattern 36 with the second coil pattern 37 and the core 10 is avoidable. Specifically, the coil board 3 is a laminated board in which a plurality of (for example, twelve layers of) single layer boards 35 (35A to 35L) are laminated. In the drawings and the description, respective layer numbers of the single layer boards 35 correspond to reference numerals A to L, and fourth layer, eighth layer, and ninth layer of the single layer boards 35 (35D, 35H, 35I) are not illustrated.

The single layer boards 35 are configured of a plurality of (for example, seven layers of) first single layer boards 35A to 35G and a plurality of (for example, five layers of) second single layer boards 35H to 35L. The first single layer boards 35A to 35G are the single layer boards on which first conductive patterns 36A to 36G are formed along the peripheral area of the first insertion hole 31 and second conductive patterns 37A to 37G are formed along the peripheral area of the second insertion hole 32. The second single layer boards 35H to 35L are the single layer boards on which only first conductive patterns 36H to 36L are formed. In the embodiment, the number of turns of the first coil pattern 36 is more than the number of turns of the second coil pattern 37 by the number of the single layer boards 35 on which only the first conductive patterns 36H to 36L are formed.

The first conductive patterns 36A to 36L and the second conductive patterns 37A to 37G are rectangular patterns formed into planar shapes on the board main bodies 35a with an insulating property, such as glass epoxy boards. The first conductive patterns 36A to 36L and the second conductive patterns 37A to 37G are provided with openings 31a, 32a adjusted to the first insertion holes 31 and the second insertion holes 32.

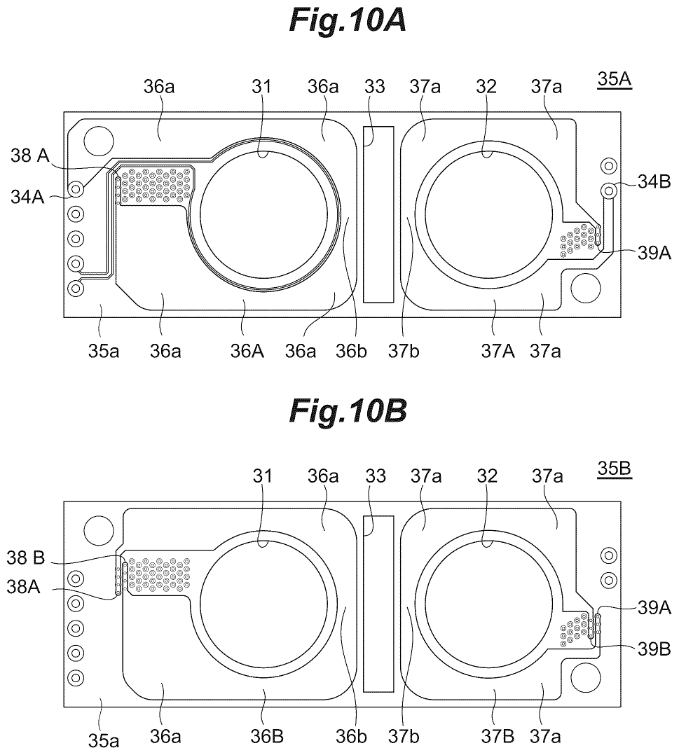

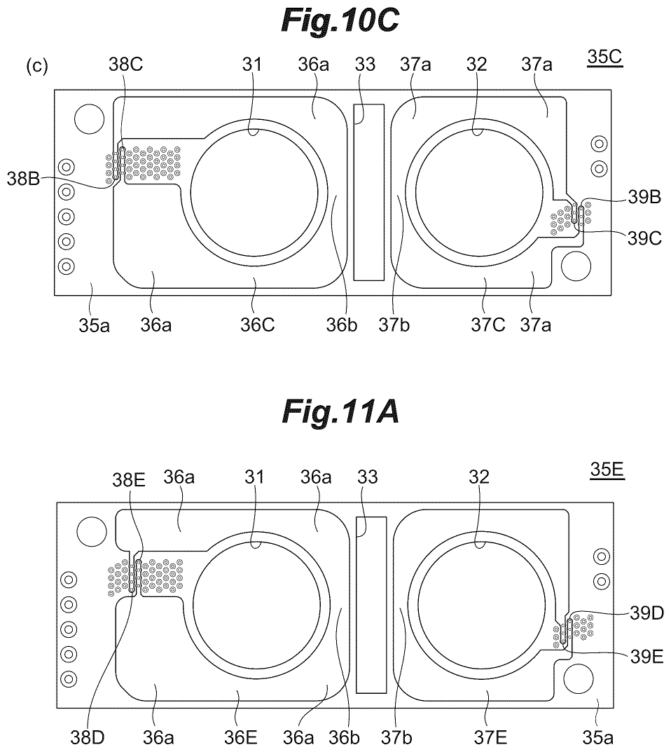

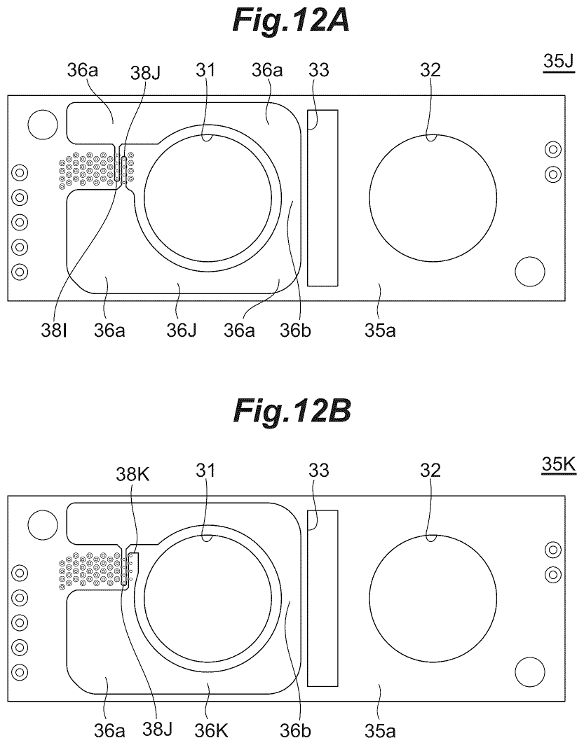

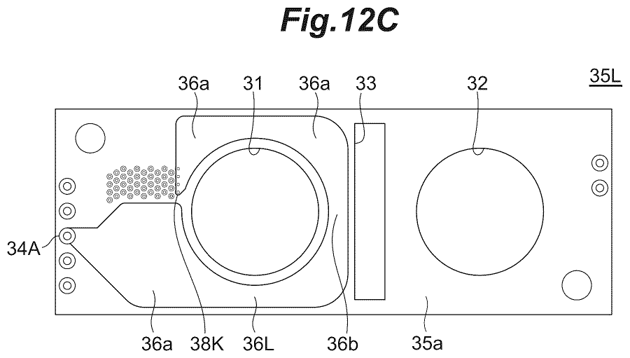

In the embodiment, only a pair of the first conductive patterns 36A, 36L positioned at the outermosts of the plurality of the laminated first conductive patterns 36A to 36L are connected to terminal portions 34A, 34A for the inverter circuit board 4A (see FIG. 10A and FIG. 12C). The first conductive patterns 36A to 36L of the neighboring single layer boards 35 are insulated by the board main bodies 35a with an insulating property described above.

The first conductive patterns 36A to 36L of the neighboring single layer boards 35 are electrically connected to one another via first conductive vias 38 such that a current flows in the same circumferential direction along peripheral areas of the openings 31a of the respective first conductive patterns 36A to 36L. Thus, the first coil pattern 36 that corresponds to the primary coil of the transformer 3A is formed with a simpler structure. The first coil pattern 36 serves as a primary coil having a configuration close to a winding wire configuration.

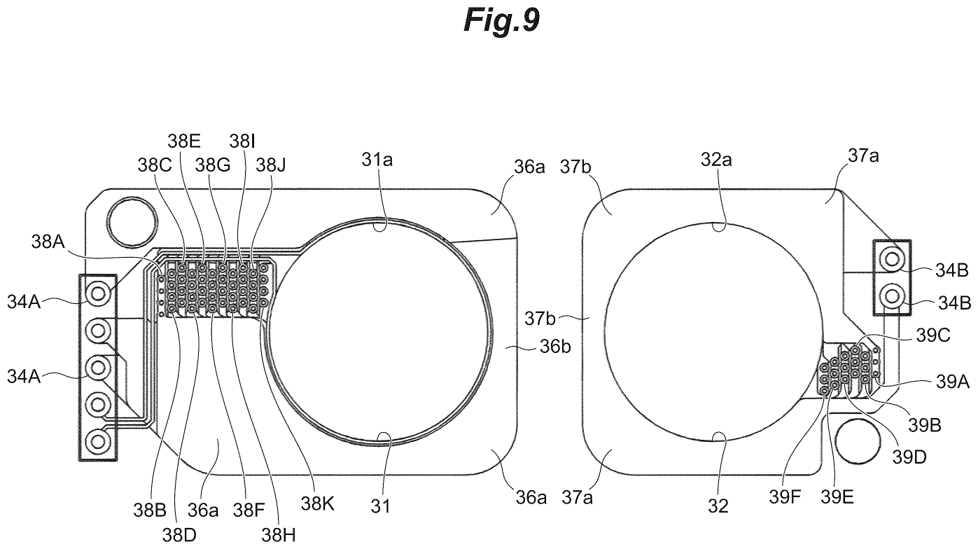

Specifically, as illustrated in FIG. 8, a plurality of groups 38A to 38K of the plurality (in FIG. 9, for example, four) of first conductive vias 38 disposed at equal intervals are arranged at intervals from the terminal portions 34A toward the opening 31a. The plurality (for example, four) of first conductive vias 38 constituting the respective groups 38A to 38K are formed to have intervals on straight lines. In the embodiment, there are eleven groups 38A to 38K of the first conductive vias 38 inside the coil board 3 in order to connect the neighboring ones of the twelve neighboring first conductive patterns 36A to 36K by the first conductive vias 38.

As illustrated in FIG. 10A and FIG. 10B, the first conductive pattern 36A on the single layer board 35 (35A) as the uppermost layer (a first layer) is connected to one terminal portion 34A for the inverter circuit board 4A. Furthermore, the first conductive pattern 36A positioned on the first layer and the first conductive pattern 36B positioned on the layer thereunder (a second layer) are connected via the group 38A of the four first conductive vias 38 closest to the terminal portion 34A. As illustrated in FIG. 10B and FIG. 10C, the first conductive pattern 36B positioned on the lower layer (the second layer) and the first conductive pattern 36C positioned on the layer thereunder (a third layer) are connected via the group 38B of the four first conductive vias 38 neighboring in a side of the opening 31a with respect to the group 38A of the four first conductive vias 38 described above.

Similarly, as illustrated in FIG. 11A to FIG. 11C, the first conductive pattern 36E on the single layer board 35 (35E) as a fifth layer and the first conductive pattern 36F on the single layer board 35 (35F) as a sixth layer are connected via the group 38E of the first conductive vias 38, and the first conductive pattern 36F on the single layer board 35 (35F) as the sixth layer and the first conductive pattern 36G on the single layer board 35 (35G) as a seventh layer are connected via the group 38F of the first conductive vias 38. As illustrated in FIG. 12A and FIG. 12B, the first conductive pattern 36J on the single layer board 35J as a tenth layer and the first conductive pattern 36K on the single layer board 35 (35K) as an eleventh layer are connected via the group 38J of the first conductive vias 38. Finally, as illustrated in FIG. 12B and FIG. 12C, the first conductive pattern 36K on the single layer board 35 (35K) as the eleventh layer and the first conductive pattern 36L on the single layer board 35 (35L) as a twelfth layer are connected via the group 38L of the first conductive vias 38, and the first conductive pattern 36L on the single layer board 35L as the twelfth layer is connected to the other terminal portion 34A for the inverter circuit board 4A.

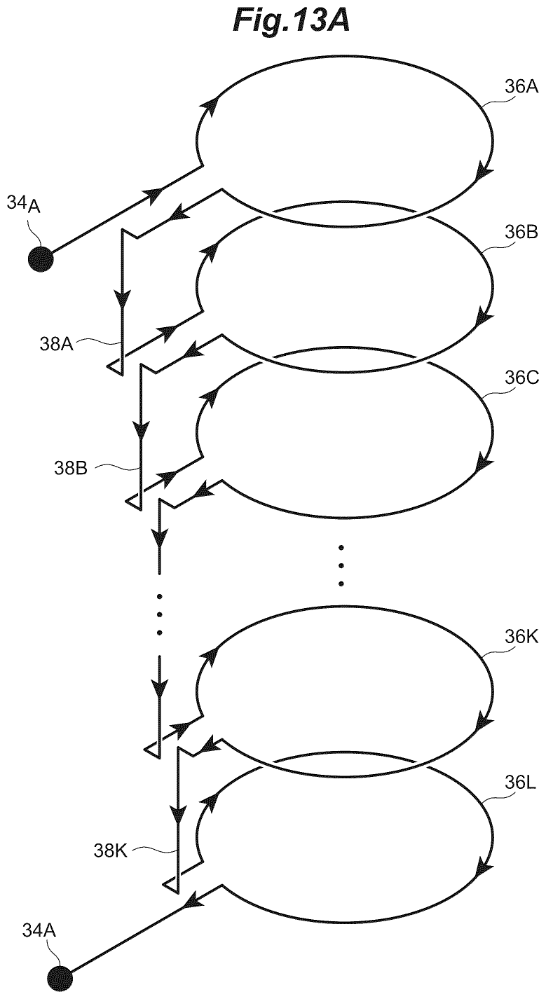

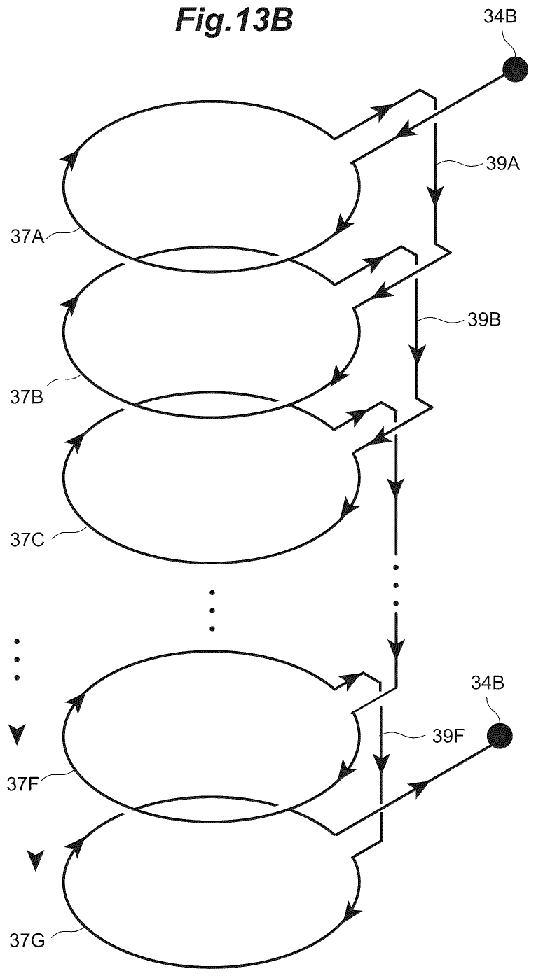

Thus, as illustrated in FIG. 13A, the electrical connection is made from the one terminal portion 34A to the other terminal portion 34A via the groups 38A to 38K of the first conductive vias 38 in the order from the first conductive pattern 36A to 36J such that the current flows in the same circumferential direction. Thus, the first coil pattern 36 corresponding to the primary coil of the transformer 3A is formed. As the number of layers increases, the groups 38A to 38K of the plurality of first conductive vias 38 connecting the first conductive patterns 36A to 36L to one another are sequentially shifted toward the side of the opening 31a. Thus, the current flowing in the first coil pattern 36 flows along the peripheral edge (circumferential edge) of the first insertion hole 31 in a circular shape, and therefore, the electric field formed in the first coil pattern 36 can be stabilized.

In the embodiment, only a pair of the second conductive patterns 37A, 37G positioned at the outermosts of the plurality of the laminated second conductive patterns 37A to 37G are connected to terminal portions 34B, 34B for the rectifier circuit board 4B (see FIG. 10A and FIG. 11C). The second conductive patterns 37A to 37G of the neighboring single layer boards 35 are insulated by the board main bodies 35a with an insulating property described above.

The second conductive patterns 37A to 37G of the neighboring single layer boards 35 are electrically connected to one another via second conductive vias 39 such that a current flows in the same circumferential direction along peripheral areas of the openings 32a of the respective second conductive patterns 37A to 37G. Thus, the second coil pattern 37 that corresponds to the secondary coil of the transformer 3A is formed with a simpler structure. The second coil pattern 37 serves as a secondary coil having a configuration close to a winding wire configuration.

Specifically, as illustrated in FIG. 9, a plurality of groups 39A to 39F of the plurality (for example, three) of second conductive vias 39 disposed at equal intervals are arranged at intervals from the terminal portions 34B toward the opening 32a. The plurality (for example, three) of second conductive vias 39 constituting the respective groups 39A to 39F are formed to have intervals on straight lines. In the embodiment, the second conductive vias 39 connect the neighboring ones of the neighboring seven second conductive patterns 37A to 37G, and there are six groups 39A to 39F of the second conductive vias 39 inside the coil board 3.

As illustrated in FIG. 10A and FIG. 10B, the second conductive pattern 37A on the single layer board 35 (35A) as the uppermost layer (the first layer) is connected to the one terminal portion 34B for the rectifier circuit board 4B. Furthermore, the second conductive pattern 37A positioned on the first layer and the second conductive pattern 37B positioned on the layer thereunder (the second layer) are connected via the group 39A of the three second conductive vias 39 closest to the terminal portions 34B. As illustrated in FIG. 10B and FIG. 10C, the second conductive pattern 37B positioned on the lower layer (the second layer) and the second conductive pattern 37C positioned on the layer thereunder (the third layer) are connected via the group 39B of the three second conductive vias 39 neighboring in a side of the opening 32a with respect to the group 39A of the three second conductive vias 39 described above.

Similarly, as illustrated in FIG. 11A and FIG. 11B, the second conductive pattern 37E on the single layer board 35 (35E) as the fifth layer and the second conductive pattern 37F on the single layer board 35 (35F) as the sixth layer are connected via the group 39E of the second conductive vias 39. Finally, as illustrated in FIG. 11B and FIG. 11C, the second conductive pattern 37F on the single layer board 35 (35F) as the sixth layer and the second conductive pattern 37G on the single layer board 35 (35G) as the eighth layer are connected via the group 39F of the second conductive vias 39, and the second conductive pattern 37G on the single layer board 35 (35G) as the eighth layer is connected to the other terminal portion 34B for the rectifier circuit board 4B.

Thus, as illustrated in FIG. 13B, the electrical connection is made from the one terminal portion 34B to the other terminal portion 34B via the groups 39A to 39F of the second conductive vias 39 in the order from the second conductive pattern 37A to 37G such that the current flows in the same circumferential direction. Thus, the second coil pattern 37 corresponding to the secondary coil of the transformer 3A is formed. As the number of layers increases, the groups 39A to 39F of the plurality of second conductive vias 39 connecting the second conductive patterns 37A to 37G to one another are sequentially shifted toward the side of the opening 32a. Thus, the current flowing in the second coil pattern 37 flows along the peripheral edge (circumferential edge) of the second insertion hole 32 in a circular shape, and therefore, the electric field formed in the second coil pattern 37 can be stabilized.

The first conductive patterns 36A to 36G formed on the first single layer boards 35A to 35G have areas larger than areas of the second conductive patterns 37A to 37G formed on the first single layer boards 35A to 35G. Thus, forming the first conductive patterns 36A to 36G and the second conductive patterns 37A to 37G on the first single layer boards 35A to 35G enables reducing the thickness of the coil board 3.

Furthermore, laminating the second single layer boards 35H to 35L on which only the first conductive patterns 36H to 36L are formed increases the number of turns of the first coil pattern 36 to be more than the number of turns of the second coil pattern 37, and therefore, the first coil pattern 36 easily generates a heat compared with the second coil pattern 37. However, since the areas of the first conductive patterns 36A to 36G are larger than the areas of the second conductive patterns 37A to 37G on the first single layer board 35A to 35G in the embodiment, the heat dissipation characteristic of the first coil pattern 36 can be enhanced.

As illustrated in FIG. 9, in plan view of the coil board 3, the first coil pattern 36 forms a circular consecutive edge portion along the first insertion hole 31 with the first conductive patterns 36A to 36L of the plurality of single layer boards 35 when only the first conductive patterns 36A to 36L of the plurality of single layer boards 35 are viewed. Similarly, in plan view of the coil board 3, the second coil pattern 37 forms a circular consecutive edge portion along the second insertion hole 32 with the second conductive patterns 37A to 37G of the plurality of single layer boards 35 when only the second conductive patterns 37A to 37G of the plurality of single layer boards 35 are viewed.

Thus, the first coil pattern 36 forms the circular consecutive edge portion along the first insertion hole 31 with the first conductive patterns 36A to 36L of the plurality of single layer boards 35, and therefore, the distribution of electric field formed by the first coil pattern 36 can be uniformized. Furthermore, the second coil pattern 37 forms the circular consecutive edge portion along the second insertion hole 32 with the second conductive patterns 37A to 37G of the plurality of single layer boards 35, and therefore, the distribution of electric field formed by the second coil pattern 37 can be uniformized.

As described above, the outer edges of the first conductive patterns 36A to 36L and the outer edges of the second conductive patterns 37A to 37G are in an approximately rectangular shape, and the first conductive patterns 36A to 36L and the second conductive patterns 37A to 37G are formed to have one sides of the outer edges of the first conductive patterns 36A to 36L and one sides of the outer edges of the second conductive patterns 37A to 37G opposed to one another on the respective first single layer boards 35A to 35G.

Such a configuration enables reducing widths of respective energized portions 36b, 37b where the first conductive patterns 36A to 36L and the second conductive patterns 37A to 37G are opposed to one another compared with the other portions, and reducing parasitic capacitances in these portions. Furthermore, triangle portions are formed at corner portions 36a, 37a of the first conductive patterns and the second conductive patterns, and these portions can be caused to act as heat dissipation portions. In particular, in plan view of the coil board 3, the center of the first insertion hole 31 is formed closer to the second insertion hole 32 than to the center of the first conductive patterns 36A to 36G, and thus, such an effect can be further developed.

With the embodiment, the coil board 3 has the first coil pattern 36 in the peripheral area of the first insertion hole 31 and has the second coil pattern 37 in the peripheral area of the second insertion hole 32, and thus, the primary coil and the secondary coil of the transformer 1A are separately provided. Thus, the parasitic capacitance between the primary coil and the secondary coil in the coil board 3 can be reduced.

### 4. Board Structure Including Coil Board 3

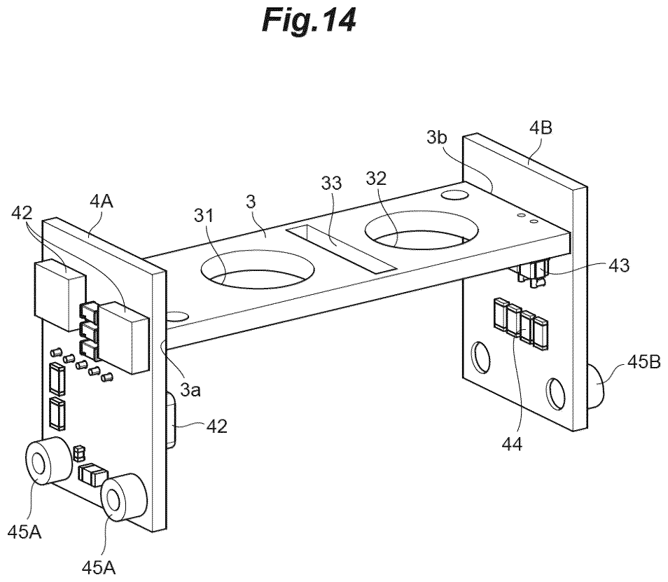

As illustrated in FIG. 14, the inverter circuit board 4A is integrally installed on the coil board 3 so as to extend in a direction perpendicular to the coil board 3 in one end 3a of the coil board 3. In the embodiment, the inverter circuit board 4A is disposed along the sidewall 21A on one side of the casing 20, and the one end (one side edge) 3a of the coil board 3 is bonded on a surface (a surface of the board main body) of the inverter circuit board 4A on which the electronic component 42 is mounted. The coil board 3 and the inverter circuit board 4A may be bonded by adhesion or may be integrated by a connection jig or the like. In the embodiment, the inverter circuit board 4A and (the first coil pattern 36) of the coil board 3 are integrally and electrically connected by soldering via a connecting terminal 41 connected to each of them.

Similarly, the rectifier circuit board 4B is integrally installed on the coil board 3 so as to extend in a direction perpendicular to the coil board 3 in another end 3b of the coil board 3. In the embodiment, the rectifier circuit board 4B is disposed along the sidewall 21B on the other side of the casing 20, and the other end (the other side edge) 3b of the coil board 3 is bonded on a surface (a surface of the board main body) of the rectifier circuit board 4B on which the electronic component 44 is mounted. The coil board 3 and the rectifier circuit board 4B may be bonded by adhesion or may be integrated by a connection jig or the like. In the embodiment, the rectifier circuit board 4B and (the second coil pattern 37) of the coil board 3 are integrally and electrically connected by soldering via a connecting terminal 43 connected to each of them.

Here, “installed on the coil board 3 extending in a direction perpendicular to the inverter circuit board 4A (the rectifier circuit board 4B) and the coil board 3” means that the inverter circuit board 4A (the rectifier circuit board 4B) is installed on the coil board 3 such that the normal line of the inverter circuit board 4A (the rectifier circuit board 4B) in a flat plate shape lies perpendicular or approximately perpendicular to the normal line of the coil board 3 in a flat plate shape. In the embodiment, the state where the inverter circuit board 4A and the rectifier circuit board 4B are installed on both the ends of the coil board 3 is a H-shaped board structure in side view. However, the board structure is not limited to this structure, and, for example, these boards may be installed on the coil board 3 such that a C-shaped or U-shaped board structure is obtained.

The embodiment enables handling the coil board 3, the inverter circuit board 4A, and the rectifier circuit board 4B as one downsized board structure. Thus, relative positions of the coil board 3, the inverter circuit board 4A, and the rectifier circuit board 4B with the core 10 are easily managed, and the workability of assembling the isolated converter 1 can be enhanced.

Furthermore, since the inverter circuit board 4A and the rectifier circuit board 4B are integrally installed on the coil board 3 so as to extend in a direction perpendicular to the coil board 3, the internal space S of the casing 20 is effectively utilizable compared with the case where those boards are arranged on the same plane. As a result, the casing 20 is compactified to attempt downsizing of the isolated converter 1, thereby enabling achieving a lowered footprint.

### 5. Installation Structure of Coil Board 3 on Casing 20

In the embodiment, the inverter circuit board 4A and the rectifier circuit board 4B are secured on the opposed sidewalls 21A, 21B of the casing 20, and thus, the coil board 3 is held inside the casing 20. Specifically, the inverter circuit board 4A is secured to the one sidewall 21A and the rectifier circuit board 4B is secured to the other sidewall 21B. As a result, the coil board 3 is supported by the casing 20 in a hanging state inside the casing 20.

The inverter circuit board 4A and the rectifier circuit board 4B are thus secured to the pair of opposed sidewalls 21A, 21B of the casing 20. Thus, deformation and distortion caused by a dimensional error and the like during installation are absorbed by the inverter circuit board 4A and the rectifier circuit board 4B, and the coil board 3 can be held in the casing 20. Thus, deformation, distortion, and the like of the coil board 3 caused by directly installing the coil board 3 on the casing 20 can be suppressed, and therefore, the coil board 3 is accurately installable on the core 10.

Here, as illustrated in FIG. 3 and FIG. 4, the spacers 45A, 45B that position the first insertion hole 31 with respect to the first magnetic portion 11a and position the second insertion hole 32 with respect to the second magnetic portion 11b are disposed between the inverter circuit board 4A and the rectifier circuit board 4B and respective inner surfaces of the pair of sidewalls 21A, 21B.

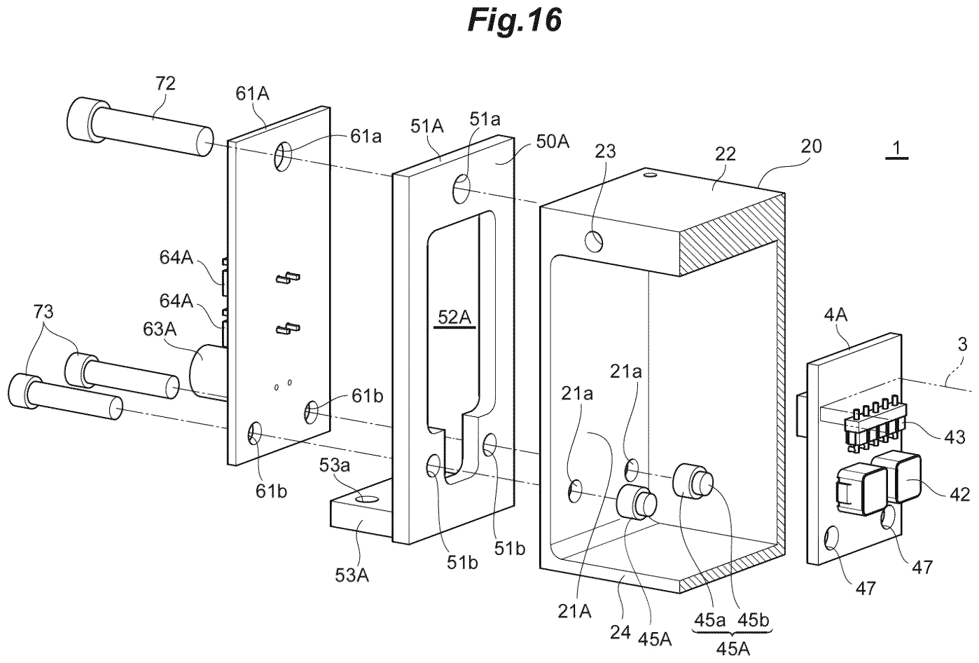

Specifically, the spacer 45A is fixedly secured to the inverter circuit board 4A with an adhesive agent or the like, and the spacer 45B is fixedly secured to the rectifier circuit board 4B with an adhesive agent or the like. As illustrated in FIG. 16, the spacer 45A is a cylindrical body in a stepped shape having a large-diameter portion 45a and a small-diameter portion 45b. The spacer 45A has the large-diameter portion 45a abutting on the inverter circuit board 4A in the stepped portion, and the small-diameter portion 45b is fixedly secured to the inverter circuit board 4A with being housed in an installation hole 47 of the inverter circuit board 4A. While it is not illustrated, the spacer 45B also has a similar shape to the shape of the spacer 45A, and the spacer 45B is fixedly secured to the rectifier circuit board 4B in a similar method to the method of the spacer 45A.

As illustrated in FIG. 4, in the embodiment, the fasteners 73 inserted through the respective sidewalls 21A, 21B are screwed in the spacers 45A, 45B and fastened, and thus, the inverter circuit board 4A and the rectifier circuit board 4B are installed on the casing 20. Specifically, as illustrated in FIG. 16, the sidewall 21A of the casing 20, the installation member 50A, and the input board 61A are provided with respective installation holes 21a, 51b, 61b through which the fasteners 73 are inserted. The respective installation holes 21a, 51b, 61b are circular-shaped through holes that do not engage with the fasteners 73.

In the embodiment, the fasteners 73 are inserted through the respective installation holes 21a, 51b, 61b of the sidewall 21A, the installation member 50A, and the input board 61A, are screwed in the spacers 45A fixedly secured to the inverter circuit board 4A, and are fastened. Furthermore, the fastener 72 is inserted through respective installation holes 51a, 61a of the installation member 50A and the input board 61A, is screwed in the sidewall 21A, and is fastened. Thus, the installation member 50A and the input board 61A, as well as the inverter circuit board 4A, can be secured to the casing 20.

Similarly, the sidewall 21B of the casing 20, the installation member 50B, and the output board 61B are also provided with installation holes. Using the fasteners 72, 73, the installation member 50B and the output board 61B, as well as the rectifier circuit board 4B, can be secured to the casing 20.

Thus, the spacers 45A are interposed between the one sidewall 21A of the casing 20 and the inverter circuit board 4A, and the spacers 45B are interposed between the other sidewall 21B of the casing 20 and the rectifier circuit board 4B. Thus, the first insertion hole 31 can be positioned at an appropriate position with respect to the first magnetic portion 11a of the core 10 and the second insertion hole 32 can be positioned at a position at which the parasitic capacitance is minimized with respect to the second magnetic portion 11b of the core 10, in the casing 20. In particular, only by fastening the fasteners 73, each of the first magnetic portion 11a and the second magnetic portion 11b of the core 10 (the divided body 11) can be positioned at a position at which the parasitic capacitance of the first insertion hole 31 or the second insertion hole 32 of the coil board 3 is minimized.

Specifically, the first insertion hole 31 and the second insertion hole 32 are circular-shaped through-holes. Therefore, the opening 31a of the first conductive pattern 36A and the opening 32a of the second conductive pattern 37A are in a circular shape. The first magnetic portions 11a, 12a and the second magnetic portions 11b, 12b of the core 10 are in an approximately cylindrical shape. In such a case, the center of the opening 31a of the first conductive pattern 36A, the axial center of the first magnetic portion 11a, and the axial center of the first magnetic portion 12a are positioned to be aligned, and the center of the opening 32a of the second conductive pattern 37A, the axial center of the second magnetic portion 11b, and the axial center of the second magnetic portion 12b are positioned to be aligned, and thus, the parasitic capacitance between the core 10 and the first conductive pattern 36A and the parasitic capacitance between the core 10 and the second conductive pattern 37A are minimizable. In addition, the electrical discharge between the core 10 and the first coil pattern 36 and the electrical discharge between the core 10 and the second coil pattern 37 are suppressible.

### 6. Mold to Casing 20

The internal space S of the casing 20 is filled with a mold material M with an insulating property, and thus, the transformer 3A, the inverter circuit board 4A, and the rectifier circuit board 4B are sealed within the internal space S of the casing 20 with the mold material M. The mold material M is made from a thermosetting resin, such as a silicone resin, an epoxy resin, or a urethane resin, and the mold material M fills the internal space S in a state of being heated to a temperature less than a hardening start temperature as necessary.

After the mold material M fills the internal space S, the isolated converter 1 is housed within a space in a decompressed state or a vacuum state to carry out a process of removing air bubbles inside the mold material M filling the internal space S of the casing 20. The temperature of the mold material M during the process is in a relatively low temperature (for example, approximately 25 to 40° C.), therefore being good in work efficiency, and the effect by the heat is less likely to work on the transformer 3A, the inverter circuit board 4A, and the rectifier circuit board 4B. Furthermore, the effect by the heat is less likely to work also on the electrolytic capacitors mounted on the input board 61A and the output board 61B. After the process of removing air bubbles, heating the mold material M to a temperature (for example, approximately 40 to 120° C.) equal to or more than the hardening start temperature enables heat-hardening the thermosetting resin of the mold material M. Thus, the transformer 3A, the inverter circuit board 4A, and the rectifier circuit board 4B are sealable in the internal space S of the casing 20 with the mold material M.

When the mold material M is made from a thermoplastic resin, such as a polystyrene resin, a polyethylene resin, or a polypropylene resin, the thermoplastic resin needs to be melted by being heated at a temperature equal to or more than a softening temperature. The temperature of the mold material M in this respect is a high temperature (for example, 100 to 150° C.), and therefore, the heat may have an effect on, not only the transformer 3A, the inverter circuit board 4A, and the rectifier circuit board 4B, but also the electrolytic capacitors 63A, 63B mounted on the input board 61A and the output board 61B.

In addition, the process of housing the isolated converter 1 in the space having a decompressed state or a vacuum state and removing air bubbles within the mold material M while the mold material M is molten needs to be performed. Therefore, an expensive vacuum furnace is necessary, and therefore, it is far from good in work efficiency. Therefore, a thermosetting resin is preferably used for the mold material M.

During use of the isolated converter 1, current is energized in the inverter circuit board 4A and the rectifier circuit board 4B, thus, a heat is generated. Here, the inverter circuit board 4A is opposed to the one sidewall at an interval so as to extend along the one sidewall 21A of the casing 20, and the mold material M fills the space between the inverter circuit board 4A and the other sidewall. Accordingly, the heat generated by the inverter circuit board 4A is easily released from the one sidewall 21A of the casing 20 via the mold material M.

Similarly, the rectifier circuit board 4B is opposed to the other sidewall 21B at interval so as to extend along the other sidewall 21B of the casing 20, and the mold material M fills the space between the rectifier circuit board 4B and the other sidewall 21B. Accordingly, the heat generated by the rectifier circuit board 4B is easily released from the other sidewall 21B of the casing 20 via the mold material M.

Thus, even when the transformer 3A, the inverter circuit board 4A, and the rectifier circuit board 4B are housed in one casing 20, the heat generated by the inverter circuit board 4A and the rectifier circuit board 4B is efficiently releasable from the pair of the sidewalls 21A, 21B of the casing.

In the embodiment, the mold material M having the relative dielectric constant lower than the relative dielectric constant of the insulating material of the board main body constituting the coil board 3 preferably fills the internal space S of the casing 20, among the mold materials M made from the above-described example resins. The relative dielectric constant of the mold material M is further preferred to be lower than the relative dielectric constant of the insulating material of the board main body constituting the inverter circuit board 4A and the rectifier circuit board 4B.

The relative dielectric constant of the mold material M is made lower than the relative dielectric constant of the insulating material of the board main body, while the mold material M filling the internal space S of the casing 20 ensures a pressure resistance of the transformer 3A, and thus, increase in parasitic capacitance caused by the mold material M can be suppressed. When the insulating material of the board main body is a glass epoxy, its relative dielectric constant is 4.0, and therefore, the relative dielectric constant of the mold material M is preferably less than 4.0 (for example, 2.0 to 3.0).

Furthermore, as described above, the input board 61A on which the electrolytic capacitor 63A and the input terminals 64A electrically connected to the inverter circuit board 4A are mounted is installed on the outer surface of the one sidewall 21A of the casing 20. The output board 61B on which the electrolytic capacitor 63B and the output terminals 64B electrically connected to the rectifier circuit board 4B are mounted is installed on the outer surface of the other sidewall 21B of the casing 20.

The electrolytic capacitors 63A, 63B have a low heat-resistant temperature compared with the other electronic components as they contain an electrolyte and the like. In consideration of such an aspect, in the embodiment, the electrolytic capacitors 63A, 63B are mounted on the input board 61A and the output board 61B, and are disposed outside with respect to the casing 20. This enables suppressing the effect of the heat transmitted from the mold material M to the electrolytic capacitors 63A, 63B when the mold material M fills the casing 20. When the thermosetting resin, such as an epoxy resin, is used for the mold material M, the mold material M is simply heat-hardened before the input board 61A and the output board 61B are installed on the casing 20.

Furthermore, the pair of installation members 50A, 50B for installing the casing 20 are disposed between the input board 61A and the one sidewall 21A and between the output board 61B and the other sidewall 21B. The installation member 50A has the space 52A formed at the portion where the input terminals 64A and the electrolytic capacitor 63A are positioned.

Specifically, the installation member 50A has the space 52A formed at the portion where the input terminals 64A and the electrolytic capacitor 63A are positioned. The input terminals 64A and the electrolytic capacitor 63A are connected inside the space 52A with a wiring (not illustrated) from the inverter circuit board 4A being inserted through an insertion hole (not illustrated) formed on one sidewall 21A of the casing 20.

Similarly, the installation member 50B has the space 52B formed at the portion where the output terminals 64B and the electrolytic capacitor 63B are positioned. The output terminals 64B and the electrolytic capacitor 63B are connected inside the space 52B with a wiring (not illustrated) from the rectifier circuit board 4B being inserted through an insertion hole (not illustrated) formed on the other sidewall 21B of the casing 20.

Furthermore, the installation members 50A, 50B have the spaces 52A, 52B formed at the portions where the electrolytic capacitors 63A, 63B are positioned, and therefore, these spaces 52A, 52B function as heat-insulating layers. As a result, the effect of the heat transmitted from the casing 20 to the electrolytic capacitors 63A, 63B can be suppressed. The heat generated by the inverter circuit board 4A and the rectifier circuit board 4B during the use of the isolated converter is released from the installation members 50A, 50B even though these spaces 52A, 52B are formed, as it is a heat with a heat amount low in thermal power per unit time compared with the heat during molding.

While the embodiment of the present invention has been described in detail above, the present invention is not limited to the embodiment, and various kinds of changes of design are allowed within a range not departing from the spirits of the present invention described in the claims.

In the embodiment, the core is the U-shaped divided core made of the pair of divided bodies, and the coil board is disposed on this divided core. However, as long as the primary-side circuit board and the secondary-side circuit board are installable on the coil board, the shape of the divided core and the shapes of the first and second coil patterns of the coil board are not specifically limited.

While in the embodiment, the first coil pattern with a greater number of turns is the primary coil and the second coil pattern with a smaller number of turns is the secondary coil, the first coil pattern with a greater number of turns may be the secondary coil and the second coil pattern with a smaller number of turns may be the primary coil depending on the usage of the transformer. Furthermore, while the first conductive pattern is electrically connected to the second conductive pattern by means of the first conductive vias and the second conductive vias such that the current directions flowing in the first coil pattern and the second coil pattern have the same circumferential direction, the first conductive pattern may be electrically connected to the second conductive pattern by means of the first conductive vias and the second conductive vias such that these directions are opposite one another.

What is claimed is:

1. An isolated converter comprising:
a transformer including a coil board having a first coil pattern that functions as a primary coil and a second coil pattern that functions as a secondary coil, and a core electromagnetically coupling the first coil pattern to the second coil pattern;
a primary-side circuit board electrically connected to the first coil pattern at one end of the coil board; and
a secondary-side circuit board electrically connected to the second coil pattern at another end of the coil board,
wherein the isolated converter includes a casing with an insulating property that houses the transformer, the primary-side circuit board, and the secondary-side circuit board,
wherein the primary-side circuit board is opposed to one sidewall at an interval so as to extend along the one sidewall of a pair of sidewalls of the casing,
wherein the secondary-side circuit board is opposed to another sidewall at an interval so as to extend along the other sidewall of the pair of sidewalls of the casing, and
wherein the casing has an internal space in which a mold material with an insulating property is filled to seal the transformer, the primary-side circuit board, and the secondary-side circuit board with the mold material in the internal space of the casing.

2. The isolated converter according to claim 1,
wherein the one sidewall has an outer surface on which an input board is installed, an electrolytic capacitor and an input terminal electrically connected to the primary-side circuit board are mounted on the input board, and
wherein the other sidewall has an outer surface on which an output board is installed, an electrolytic capacitor and an output terminal electrically connected to the secondary-side circuit board are mounted on the output board.

3. The isolated converter according to claim 2,
wherein a pair of installation members for installing the casing are disposed between the input board and the one sidewall and between the output board and the other sidewall, and
wherein each of the installation members has a space formed at a portion where the electrolytic capacitor is positioned.

4. The isolated converter according to claim 1,
wherein the internal space of the casing is filled with a mold material having a relative dielectric constant lower than a relative dielectric constant of an insulating material of the board main body constituting the coil board, for the mold material.

5. The isolated converter according to claim 1,
wherein the primary-side circuit board is integrally installed on the coil board so as to extend in a direction perpendicular to the coil board at the one end of the coil board, and
wherein the secondary-side circuit board is integrally installed on the coil board so as to extend in a direction perpendicular to the coil board at the other end of the coil board.

6. The isolated converter according to claim 5,
wherein the primary-side circuit board and the secondary-side circuit board are secured on a pair of opposed sidewalls of the casing to hold the coil board in the casing.

7. The isolated converter according to claim 6,
wherein the coil board is provided with a first insertion hole and a second insertion hole, the first insertion hole has a peripheral area where the first coil pattern is formed, and the second insertion hole has a peripheral area where the second coil pattern is formed,
wherein the core has a first magnetic portion inserted through the first insertion hole and a second magnetic portion inserted through the second insertion hole, and
wherein spacers that position the first insertion hole with respect to the first magnetic portion and position the second insertion hole with respect to the second magnetic portion are disposed between the primary-side circuit board and the secondary-side circuit board and respective inner surfaces of the sidewalls.

8. The isolated converter according to claim 7,
wherein the spacer is fixedly secured to each of the primary-side circuit board and the secondary-side circuit board, and
wherein a fastener inserted through each of the sidewalls is screwed in the spacer to install the primary-side circuit board and the secondary-side circuit board on the casing.

9. The isolated converter according to claim 1,
wherein the isolated converter is a DC-DC converter,
wherein the primary-side circuit board is an inverter circuit board that includes a switching element, converts a DC power into an AC power by the switching element, and supplies the AC power to the coil board, and
wherein the secondary-side circuit board is a rectifier circuit board that rectifies a current output from the coil board.
